(19) United States
(12) Patent Application Publication
(10) Pub. No.: US 2020/0292654 A1
(43) Pub. Date: Sep. 17, 2020

(54) ANTENNA APPARATUS

(71) Applicant: NEC Corporation, Minato-ku, Tokyo (JP)

(72) Inventor: Ryosuke KUMAGAI, Tokyo (JP)

(73) Assignee: NEC Corporation, Minato-ku, Tokyo (JP)

(21) Appl. No.: 16/086,047

(22) PCT Filed: Mar. 30, 2017
(86) PCT No.: PCT/JP2017/013344

§ 371 Date: Sep. 18, 2018

(30) Foreign Application Priority Data
Mar. 30, 2016 (JP) 2016-068848

(51) Int. Cl. G01S 3/04; H01Q 21/20; H01Q 1/32

(52) U.S. Cl. CPC G01S 3/043; H01Q 1/3275; H01Q 21/20

(57) ABSTRACT

An antenna apparatus 1 includes a recess 3 formed in a part of a conveyance or a building, an antenna element 4 disposed in the recess 3, and a cover or an insulating material closing a mouth 3b of the recess 3. The recess 3 includes a bottom 3a, the mouth 3b and a side wall 3c connecting the bottom 3a and the mouth 3b, a shape of the recess 3 widens from the bottom 3a toward the mouth 3b, and the bottom 3a and the side wall 3c are made of a conductor. An array antenna configured to detect an incoming direction of a radio wave is formed by a plurality of antenna elements 4.

### TECHNICAL FIELD

The present invention relates to an antenna apparatus.

### BACKGROUND ART

When an antenna apparatus is mounted on conveyances such as cars or buildings, there is a risk of impairing an external appearance thereof because antenna elements project outward from a surface of the conveyance or the building. Therefore, Patent Literature 1 and 2 disclose a configuration where a recess is formed on a surface of a conveyance or a building and antenna elements are arranged in the recess.

For purposes of monitoring a radio wave environment etc., there is a demand for means for detecting an incoming direction of radio waves over a wide frequency band with high precision. Therefore, there is a method using an array antenna where a plurality of antenna elements are arranged, in which information on a phase and the like of radio waves received through each of the plurality of antenna elements is used. Patent Literature 3 discloses an antenna apparatus that detects an incoming direction of radio waves.

### CITATION LIST

### Patent Literature

Patent Literature 1: Japanese Patent No. 2692253

Patent Literature 2: Japanese Unexamined Patent Application Publication No. 2003-309409

Patent Literature 3: Japanese Unexamined Patent Application Publication No. 2002-71776

### SUMMARY OF INVENTION

### Technical Problem

An embedded antenna for cars disclosed in Patent Literature 1 is an antenna for a specific frequency band which has a fractional bandwidth of about 20% and a gain is not taken into consideration. Therefore, it is difficult to apply this embedded antenna to uses in which a gain needs to be secured over a wide band (e.g., detection of an incoming direction in monitoring of the radio wave environment).

In a configuration disclosed in Patent Literature 2, a plurality of antenna elements are encapsulated with molded resin and the molded resin encapsulating the plurality of antenna elements is fixed in a recess with an adhesive, a double-faced tape, or a bolt, etc. Thus, a task for mounting an antenna apparatus on a conveyance or a building, especially a task for fixing antenna elements, is complicated. Further, in Patent Literature 2, no method for obtaining stable characteristics over a wide frequency band and no measure against variations in the characteristics caused by an approach of persons or objects are taken into consideration.

There is a possibility that an antenna apparatus that detects a radio direction (incoming direction of radio waves) by using a plurality of antenna elements as described in Patent Literature 3 may significantly impair an external appearance of a conveyance or a building. An array antenna for precisely detecting an incoming direction of radio waves needs to have stable frequency characteristics over a wide band, be less susceptible to variations in these characteristics caused by persons or objects present inside a conveyance or a building, and optimize distances between antenna elements according to a frequency band where a detection is performed. Therefore, there are some restrictions on the size and/or the position of the antenna elements, and as a result it is difficult to arrange the antenna elements so that they are inconspicuous in appearance. Thus, for example, as shown in FIG. 22 of Patent Literature 3, an external appearance is significantly impaired since a large mounting space is necessary to mount a plurality of antenna elements for detecting a radio direction on a car.

In order to reduce the possibility of impairing an external appearance of a conveyance or a building, a glass antenna which is embedded in or printed on a window pane has been in practical use. However, there is a problem that characteristics of a glass antenna are easily varied due to an approach of persons or objects. Further, since there are considerable restrictions on the installation place, it has been difficult to arrange a plurality of glass antennas at arbitrary intervals.

Therefore, an object of the present invention is to solve the problem described above, and provide an antenna apparatus capable of being easily mounted on a conveyance or a building and detecting an incoming direction of radio waves with high precision without significantly impairing an external appearance.

### Solution to Problem

An antenna apparatus according to the present invention includes an array antenna including a plurality of antenna elements and configured to detect an incoming direction of a radio wave, including: a recess formed in a part of a conveyance or a building, an antenna element disposed in the recess, and a cover or an insulating material closing a mouth of the recess, in which the recess includes a bottom, the mouth and a side wall connecting the bottom and the mouth, and a shape of the recess widens from the bottom toward the mouth, and the bottom and the side wall are made of a conductor.

### Advantageous Effects of Invention

According to the present invention, an antenna is easily mounted on a conveyance or a building, and an incoming direction of radio waves can be precisely detected without significantly impairing an external appearance.

### BRIEF DESCRIPTION OF DRAWINGS

FIG. 1 is a cross-sectional view schematically showing the antenna apparatus according to an embodiment of the present invention;

FIG. 2 is a perspective view showing the antenna apparatus including conical-shaped antenna elements according to other embodiments of the present invention;

FIG. 3 is a cross-sectional view schematically showing a comparative example of the antenna apparatus shown in FIG. 2;

FIG. 4 is a cross-sectional view schematically showing an example of the antenna apparatus shown in FIG. 2;

FIG. 5 is a cross-sectional view schematically showing other examples of the antenna apparatus shown in FIG. 2;

FIG. 6 is a graph showing a calculation result of a horizontal gain at each frequency of the antenna apparatuses shown in FIGS. 3 to 5;

FIG. 7 is a perspective view showing an example of a car with the antenna apparatus mounted thereon according to the present invention;

FIG. 8 is a cross-sectional view schematically showing the antenna apparatus according to other embodiments of the present invention;

FIG. 9 is a cross-sectional view schematically showing a modified example of the antenna apparatus shown in FIG. 1;

FIG. 10 is a cross-sectional view schematically showing other modified examples of the antenna apparatus shown in FIG. 1;

FIG. 11 is a perspective view showing an example of a car with other antenna apparatuses mounted thereon according to the present invention;

FIG. 12 is a schematic view showing an inside of a car mounted with the antenna apparatus shown in FIG. 11;

FIG. 13A is a cross-sectional view showing an example of the antenna apparatuses according to other embodiments of the present invention; and

FIG. 13B is a cross-sectional view showing other examples of the antenna apparatuses according to other embodiments of the present invention.

### DESCRIPTION OF EMBODIMENTS

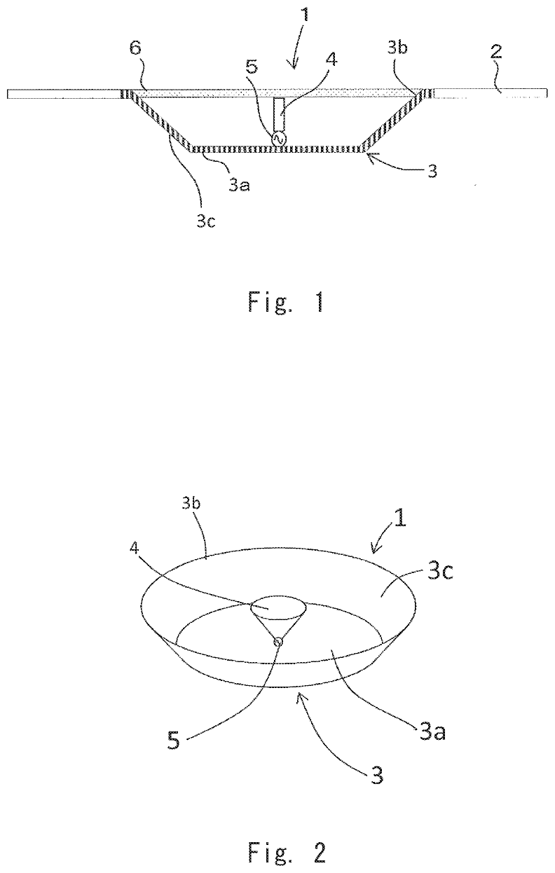

Embodiments of the present invention are explained hereinafter with reference to the drawings. FIG. 1 shows a basic configuration of an antenna apparatus 1 according to the present invention. In this example, the antenna apparatus 1 is mounted on a roof part made of a conductor, which is used as a mounting surface 2, of a conveyance such as a car. In other words, a recess 3 is formed on a part of the roof part. The shape of this recess 3 widens from a bottom 3a toward a mouth 3b, and a side wall 3c connecting the bottom 3a with the mouth 3b is inclined at an angle of 120° or larger, preferably at an angle of 135° or larger, with respect to the bottom 3a. The bottom 3a and the side wall 3c are electrically connected with each other and constitute a ground part (embedded ground plate). The ground part is made of a conductor and is electrically connected with the mounting surface 2 where the recess 3 is formed. An antenna element 4 (e.g., monopole antenna) is positioned in the recess 3. A feeding point 5 is provided on the ground part and is connected with the antenna element 4. The mouth 3b is closed by a cover 6.

The side wall 3c of this antenna apparatus 1 is inclined and hence a reflected wave generated on the side wall 3c travels toward the upper mouth 3b. Therefore, there is an effect that a horizontal gain is stabilized. Further, since the antenna element 4 is separated from the space below the ground part by the ground part, the antenna element 4 is less likely to be affected by a person or an object in the space below the ground part. Therefore, there is an advantageous effect that antenna characteristics are stabilized. Further, since the mounting surface 2 is made of a conductor and is electrically connected to the ground part, the ground part substantially becomes very large. Therefore, it is less likely to be affected by a person or an object indoors.

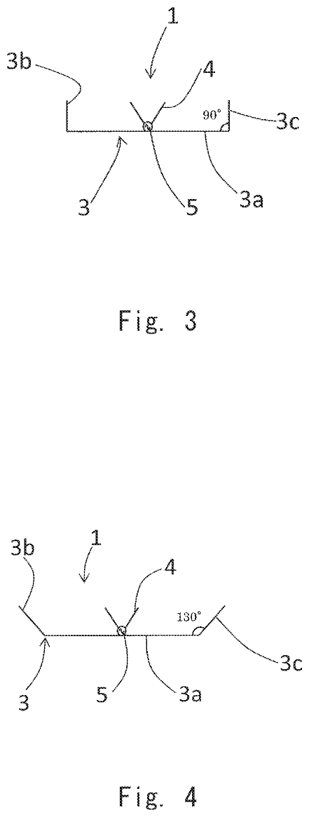

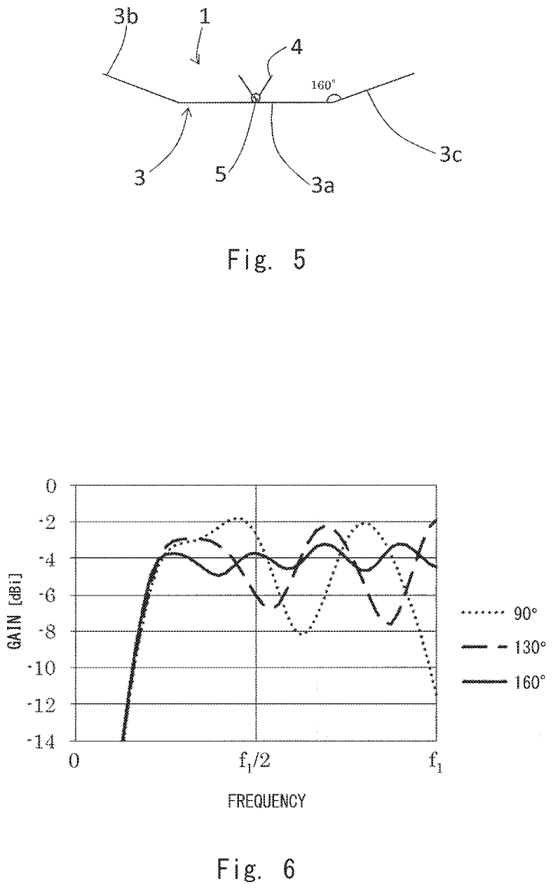

FIG. 2 shows an antenna apparatus 1 including a conical-shaped antenna element 4 having a wide band property as an application example of the antenna apparatus 1 shown in FIG. 1. The cover 6 is omitted for an illustration purpose in this FIG. 2 and in FIGS. 3 to 5, 7, 8 and 11 described later. FIGS. 3 to 5 show three examples of the antenna apparatus 1 each of which is composed of a conical-shaped antenna element 4 and a ground part. In these antenna apparatuses 1, the inclination angles of the side wall 3b with respect to a horizontal direction (which is parallel to the bottom 3a in these examples) are 90°, 130° and 160°, respectively. FIG. 6 shows a result of horizontal gains in these antenna apparatuses 1 calculated by carrying out electromagnetic field simulations. A height of the side wall 3b is one half of a wavelength at a calculated upper-limit frequency fl. It can be confirmed from FIG. 6 that the more the inclination angle is increased as the side wall 3b is inclined, the smaller the variations caused by changes in the frequencies become, and hence these characteristics can be made more stable.

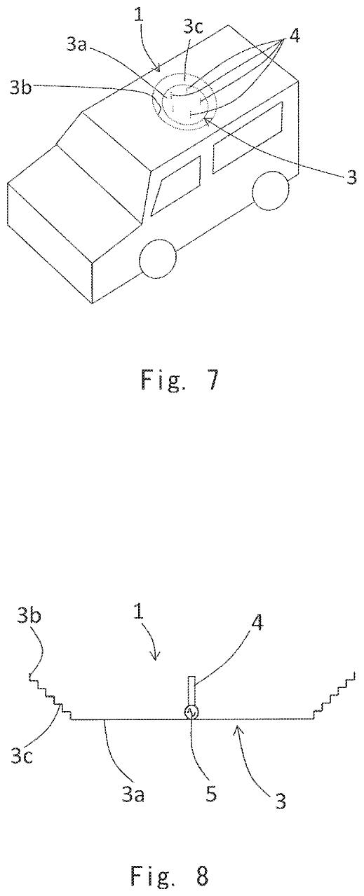

The number of antenna elements 4 arranged in one recess 3 is not limited to one and a plurality of antenna elements 4 can be arranged in the recess 3. FIG. 7 shows a configuration in which a circular array antenna with a plurality of antenna elements 4 arranged in one recess 3 is embedded in a roof part of a conveyance. The installation place of a glass antenna is limited to a glass part and therefore flexibility in constructing an array antenna is low. In contrast, in the present invention, a plurality of antenna elements 4 are arranged at arbitrary intervals and hence it is possible to provide an array antenna that is less conspicuous in appearance.

The shape of the antenna element 4 is not limited to the linear shape as shown in FIG. 1 or the conical shape as shown in FIG. 2. That is, the antenna element 4 may have a variety of arbitrary shapes such as a folded-line shape, a planer shape, and a three-dimensional shape. Further, a matching element may be attached to the feeding point 5. Moreover, a short-circuit part may be provided between the antenna element 4 and the ground part as in an inverted-F antenna. In the case where electric power is supplied by using a coaxial cable, an influence of the cable can also be reduced by providing a ferrite core around the coaxial cable.

The ground part composed of the bottom 3a and the side wall 3c of the recess 3 may be a variety of conductors such as a conductor plate, a conductor thin film, a punching metal, or a conductor net. Further, it may have a structure in which the conductor is held by an insulator. Moreover, the shape of the ground part is not limited to a truncated-cone shape as shown in FIG. 2 and may instead be an arbitrary shape in which the side wall 3c is inclined. The inclination angle of the side wall 3c does not have to be constant and the bottom 3a may be inclined as well. The recess 3 may also have such a shape that the bottom 3a and the side wall 3c are seamlessly formed as one piece. For example, the recess 3 has an inverted conical shape. Further, the side wall 3c may have a step shape shown in FIG. 8 or a curved-surface shape, though it is not shown.

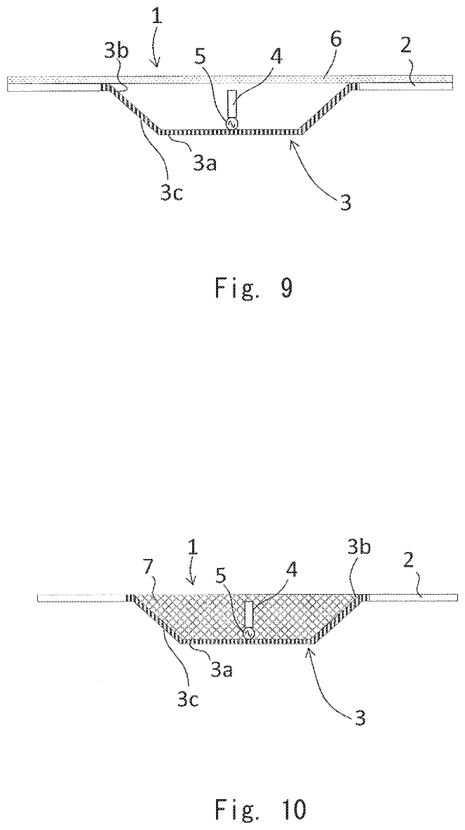

The cover 6 covering the recess is not limited to a plate or the like which is placed only over the ground part. That is, the cover 6 may be a plate or the like that is placed so as to cover an area wider than the ground part, including the mounting surface 2 as shown in FIG. 9. A structure serving as a support may be provided between the ground part and the cover 6 in order to support the cover 6. Further, instead of using the cover 6, it may have a structure in which the recess 3 is filled with an insulating material 7 as shown in FIG. 10. Further, both the cover 6 and the insulating material 7 may be used in combination.

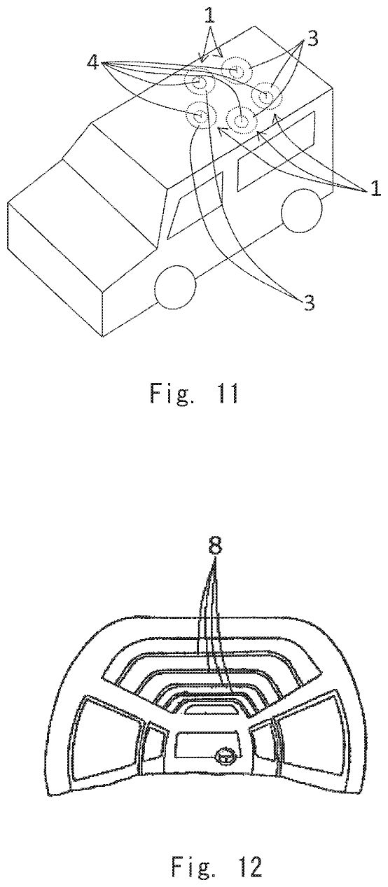

The number of antenna elements 4 arranged in the recess 3 is not limited to one and a plurality of antenna elements can be arranged in the recess 3. In the present invention, a plurality of antenna elements 4 may be arranged in one recess 3 as shown in FIG. 7 in order to form an array antenna for detecting an incoming direction of radio waves. However, the antenna array may instead have a configuration in which a plurality of recesses 3 in each of which one antenna element 4 is disposed are formed as shown in FIG. 11. Further, an arbitrary number of recesses 3 in which an arbitrary number of antenna elements 4 are arranged may be formed. Regarding the electrical connection between the side wall 3c and the mounting surface 2, and that between the side wall 3c and the bottom 3, a method in which they are electrically connected to each other over the whole circumference, a method in which they are electrically connected to each other at a plurality of points, or a method in which they are connected to each other through a capacitive coupling in a high-frequency manner may be used. Further, depending on a desired performance, they may not be connected to each other. The antenna apparatus according to this embodiment detects an incoming direction of radio waves by using a well-known MUSIC method etc. in which a direction is determined by processing amplitudes and phases of radio waves received through a plurality of antenna elements 4. However, an incoming direction of radio waves may be detected by other methods. In this embodiment, as described above, a plurality of antenna elements 4 constitute an array antenna that detects an incoming direction of radio waves.

The antenna element 4 may be a ground-type antenna element 4 such as a monopole type, or other types of antenna elements 4 such as a dipole-type antenna element 4 etc. In the case of using a dipole-type antenna element 4, the bottom 3a and the side wall 3b are also preferably made of a conductor. In the case of disposing the above-described dipole-type antenna element 4 between the bottom 3a and the side wall 3b, and the cover 6, the advantageous effect that this antenna element 4 is less susceptible to reflection in the side wall 3b can be obtained, as in the case of the monopole-type antenna element 4. In the antenna apparatus 1 according to this embodiment, the entire recess 3 can be removed. Therefore, a maintenance can be easily performed and the antenna apparatus can be easily installed or replaced when necessary.

Functions and effects of the antenna apparatus 1 according to the present invention will be described hereinafter. The antenna apparatus 1 that detects an incoming direction of radio waves often needs to cover a wide frequency band such as when monitoring a radio wave environment. When there is an object or the like which causes a reflection around the antenna apparatus 1, a false image tends to be generated at a specific frequency according to a distance between the antenna apparatus 1 and the object. Therefore, it has been difficult to mount the antenna apparatus on a conveyance or the like so that it is inconspicuous in appearance. In contrast to this, the antenna apparatus 1 according to the present invention can reduce an influence of a reflection in a wide frequency range and detect a direction over a wide band by providing the recess 3 in the mounting surface 2 such as a roof part of a conveyance and disposing the antenna element 4 in the recess 3. The inclination angle of the side wall 3c with respect to the bottom 3a (horizontal surface) is at least 120° or larger, preferably about 135° or larger.

Further, it is possible to obtain a stable gain over a wide band by forming a shape of the antenna element 4 into a three-dimensional shape such as a conical shape. Thus, it is possible to obtain good characteristics as the antenna apparatus 1 that detects an incoming direction of radio waves by a combination of the side wall 3c having an inclination and the bottom 3a with the three-dimensional shape antenna element 4.

The configuration in which a plurality of small recesses 3 is formed as shown in FIG. 11 is effective especially when a mechanical strength is weakened by forming a large recess 3. For example, the recesses 3 can be formed in gaps between frames 8 of a roof part of a conveyance while leaving the frames 8 as they are as shown in FIG. 12 showing a state in which an interior panel in a conveyance is removed, and hence an array antenna for detecting a direction can be formed while maintaining the strength of the conveyance.

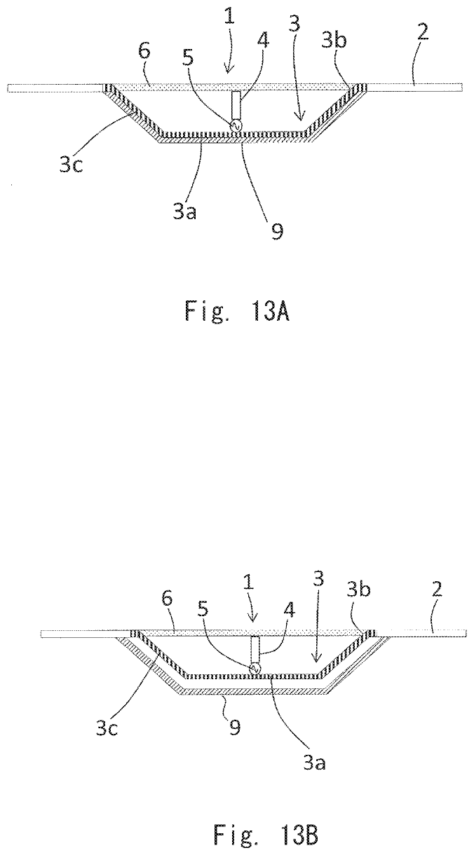

The antenna apparatus 1 according to the present invention has a feature that its characteristics hardly changes even when persons or objects approach the antenna apparatus since the antenna element 4 is separated, by the bottom 3a and the side wall 3c which are made of a conductor, from the space below them. In addition, as shown in FIG. 13A, it is possible to make the characteristics more resistant to changes by adding an inside cover 9 made of an insulator that covers the bottom 3a and the side wall 3c to isolate them from the space below (space inside the conveyance or the building). The inside cover 9 covers the surface of the bottom 3a and the side wall 3c on the side opposite to the mouth 3b. The reason for this covering is as follows. When the bottom 3a and the side wall 3c made of a conductor come into contact with a human body or the like, a high frequency current flows into them and their characteristics are changed. However, it is possible to prevent this change by preventing the contact between them. Further, a capacitive coupling slightly causes an adverse effect even when there is no such contact. Therefore, the above change can be more effectively prevented by moving the inside cover 9 away from the bottom 3a and the side wall 3c which are made of a conductor as shown in FIG. 13B. Thus, a structure may be provided in which the inside cover 9 covers the surface of the bottom 3a and the side wall 3c on the side opposite to the mouth 3b with an interval therebetween. Further, a similar effect can be obtained by increasing the thickness of the inside cover 9, instead of moving it away. It is effective to form the inside cover 9 by using a material having a small relative dielectric constant to reduce its capacitance.

Although the present invention is explained above with reference to embodiments, the present invention is not limited to the above-described embodiments. Various modifications that can be understood by those skilled in the art can be made to the configuration and details of the present invention within the scope of the invention.

This application is based upon and claims the benefit of priority from Japanese patent applications No. 2016-68848, filed on Mar. 30, 2016, the disclosure of which is incorporated herein in its entirety by reference.

### REFERENCE SIGNS LIST

1 ANTENNA APPARATUS
2 MOUNTING SURFACE
3 RECESS
3a BOTTOM
3b MOUTH
3c SIDE WALL
4 ANTENNA ELEMENT
5 FEEDING POINT
6 COVER
7 INSULATING MATERIAL
8 FLAMES
9 INSIDE COVER

What is claimed is:

1. An antenna apparatus comprising an array antenna including a plurality of antenna elements and configured to detect an incoming direction of a radio wave, comprising:
a recess formed in a part of a conveyance or a building, an antenna element disposed in the recess, and a cover or an insulating material closing a mouth of the recess, wherein
the recess includes a bottom, the mouth and a side wall connecting the bottom and the mouth, a shape of the recess widens from the bottom toward the mouth, and the bottom and the side wall are made of a conductor.

2. The antenna apparatus according to claim 1, wherein the bottom and the side wall constitute a ground part of a ground-type antenna.

3. The antenna apparatus according to claim 1, wherein the side wall has an inclined-surface shape or a step shape.

4. The antenna apparatus according to claim 1, wherein a plurality of recesses are formed on a conveyance or a building, and the array antenna, which is configured to detect an incoming direction of radio waves, is formed by at least one antenna elements respectively arranged in each of the plurality of the recesses.

5. The antenna apparatus according to claim 4, wherein the recesses are respectively formed in a plurality of places between frames of a body of a car.

6. The antenna apparatus according to claim 1, wherein a plurality of the antenna elements are disposed in one recess.

7. The antenna apparatus according to claim 1, wherein a feeding point is provided on the bottom or the side wall, and the feeding point is connected with the antenna element.

8. The antenna apparatus according to claim 1, wherein an angle between the side wall and the bottom is 120° or larger.

9. The antenna apparatus according to claim 8, wherein an angle between the side wall and the bottom is 135° or larger.

10. The antenna apparatus according to claim 1, further comprising an inside cover covering a surface of the bottom and the side wall on the side opposite to the mouth.
